(19) United States
(12) Patent Application Publication
(10) Pub. No.: US 2020/0050693 A1
(43) Pub. Date: Feb. 13, 2020

(54) TECHNIQUES AND ARCHITECTURES FOR TRACKING A LOGICAL CLOCK ACROSS NON-CHRONOLOGICALLY ORDERED TRANSACTIONS

(71) Applicant: salesforce.com, Inc., San Francisco, CA (US)

(72) Inventors: Olumayokun Obembe, Concord, CA (US); Alex Ovesea, Aurora (CA); Jason Woods, Toronto (CA); Ping-Hsiu Hsieh, San Francisco, CA (US); IIan Ginzburg, St. Pancrasse (FR); Matthieu Bloch, San Francisco, CA (US); Pierre-Yves Chevalier, San Francisco, CA (US); Scott Ware, Alamo, CA (US); Christophe Mourot, San Francisco, CA (US); Dylan Hingey, San Francisco, CA (US)

(21) Appl. No.: 16/057,685

(22) Filed: Aug. 7, 2018

(51) Int. Cl. G06F 17/30

(52) U.S. Cl. CPC G06F 17/30377; G06F 17/30336; G06F 17/30442; G06F 17/30371

(57) ABSTRACT

Managing indexing transactions in a database environment using at least a main database and at least one corresponding clone database. A time associated with a database request is determined. A lag time associated with data in a secondary database is determined. Data to service the database request is retrieved from the secondary database if the lag time is less than a pre-selected tolerance time for corresponding data. Data to service the database request is retrieved from the primary database if the lag time is greater than a pre-selected tolerance time for corresponding data. A response to the database request with the retrieved data is generated.

### TECHNICAL FIELD

Embodiments relate to techniques for managing database transactions in a computing environment having one or more databases. More particularly, embodiments relate to techniques for managing indexing transactions in a database environment using at least a main database and at least one corresponding clone database, where the database environment can be a multitenant database environment.

### BACKGROUND

Active database environments can quickly become very complex and difficult to manage. For example, a database may become overloaded with transactions in a busy or complex environment. As a result, various techniques have been developed to reduce the load on the database. However, these techniques often result in increased complexity and overhead.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of a database environment having a primary database and a secondary database.

FIG. 2 is a timing illustration of two transactions within a database environment.

FIG. 3 is a timing illustration of two transactions within a database environment having a primary database and a standby (secondary) database.

FIG. 4 is a flow diagram corresponding to one embodiment of a technique for tracking transactions.

FIG. 5 illustrates a block diagram of an environment where an on-demand database service might be used.

FIG. 6 illustrates a block diagram of an environment where an on-demand database service might be used.

### DETAILED DESCRIPTION

In the following description, numerous specific details are set forth. However, embodiments of the invention may be practiced without these specific details. In other instances, well-known structures and techniques have not been shown in detail in order not to obscure the understanding of this description.

In one embodiment, in order to reduce the load on the database indexing can be read from a copy of the database. The copy can be, for example, a read-only copy. This read-only copy is also referred to herein as “ROCS” meaning read-only clone for scale. However, the techniques described herein can also be applied to other backup or duplicate or secondary database configurations. The duplicate/clone database is replicated from the primary database and there is some delay (e.g., seconds to minutes) between the data in the primary database and the data in the duplicate database.

When implementing indexing in an environment having a duplicate database, the delay must be considered to provide correct data so that the system does not attempt to fetch from the duplicate database when the desired data is not yet available there. Under certain conditions, indexing of older versions of data can occur after the indexing of more recent versions, which results in overwriting the indexed content and providing stale data until it is updated or indexed again. Thus, a solution to this condition is required.

In one embodiment, when indexing data is fetched and indexed from one or more of the main database and the ROCS based on the “freshness” of the data to be fetched. The concept of “freshness” is discussed in further detail below. In various embodiments, the freshness of data is not directly related to the modification date of the data, but instead on the date/time at which the indexing batch was scheduled. The concept is to provide a view consistent with when the indexing batch was submitted.

In one embodiment, a new database connection can be conditionally established with the ROCS based on a timestamp to which the ROCS has caught up replicating the primary database. In one embodiment, the call to the ROCS conditionally established if the ROCS is caught up to the primary database, which can be determined utilizing an INSTANT or other timestamp indicator, for example.

In one embodiment, indexing logic can use the two connections (to the primary database and to the ROCS). In one embodiment, the primary database is used at least for index tracking and the ROCS can be used to fetch data to be indexed. In one embodiment, index tracking (e.g., cluster metadata, sequence numbers, indexing rows) utilize the primary database and the ROCS is utilized for fetching database content when appropriate (as described in greater detail below).

In one embodiment, in order to guarantee that the ROCS is only used when it stores the required data, the date/time to which the ROCS has been replicated can be compared to the date/time when the indexing batch was scheduled to be processed. If the ROCS is up to date an INSTANT (or other marker) greater than or equal to the INSTANT (or other marker) when the batch was created, the ROCS contains the data that the batch covers and can be used to fetch the data to index the batch.

In one embodiment, the time that data is changed is captured (e.g., modstamp or similar). This time can be, for example, the wall clock time (e.g., 13:46:22) and/or date (20180623) that the data was changed. The data change time is earlier than the transaction time (e.g., SCN) in the database. For example, in a large transaction the elapsed time between when the data was modified and when the transaction was committed can be significant.

In one embodiment, in the read-only database, the data change arrival time is not the data change time (e.g., modstamp), but the transaction commit time (e.g., SCN). In one embodiment, when attempting to read from the read-only database, in order to reduce the risk of a logical corruption, the transaction commit time is not relied on. In one embodiment, an approximate lag time is determined by adding, for example, the time required to process the received changes (e.g., an apply lag), network lag time, other transmission lag time, etc. This can be referred to as the clock lag time.

In one embodiment, if the clock lag time is less that a pre-selected tolerance (e.g., 5 seconds, 45 seconds, 2 minutes, 5 minutes), then the requested data is read from the read-only database rather than the primary (e.g., read-write) database. Under these conditions there is a low risk of data corruption. In one embodiment, if data corruption occurs during indexing, a second index pass will correct the corruption. In one embodiment, if the clock lag time is greater than the pre-selected tolerance, then the requested data is read from the primary database.

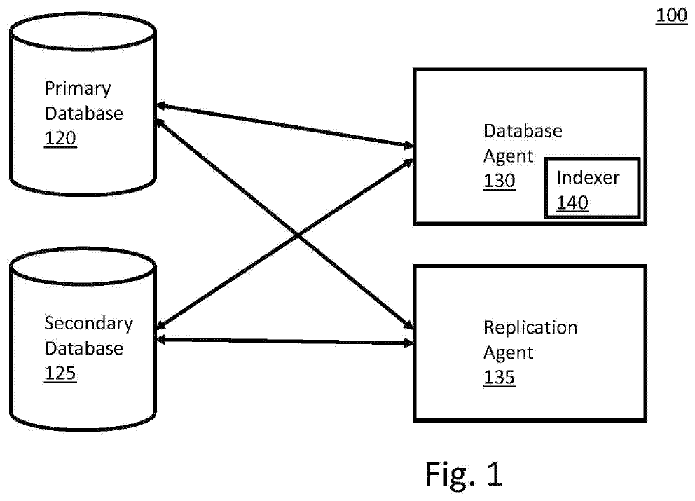

FIG. 1 is a block diagram of a database environment having a primary database and a secondary database. The database environment of FIG. 1 can have more and/or different components. Further, the components of FIG. 1 can be part of a multitenant database environment, embodiments of which are described in greater detail below.

In one embodiment, primary database 120 is a read/write database that is used for most transaction in database environment 100. In one embodiment, secondary database 125 is used for a selective set of transactions in database environment 100. Secondary database 125 can be, for example, a read-only database (e.g., ROCS). Secondary database 125 is described as being utilized for certain functionality in the present description; however secondary database 125 can additionally support additional types of functionality not described herein.

In one embodiment, replication agent 135 operates to copy data from primary database 120 to secondary database 125. Any technique can be utilized to copy data between the databases. As discussed above, there is some delay between data changes (e.g., write, update, delete) in primary database 120 and the corresponding data in secondary database 125, which can depend on one or more factors.

In one embodiment, database agent 130 includes indexer 140, which can operate utilizing the techniques described herein. In one embodiment, indexer 140 operates to index data in database environment 100 utilizing both primary database 120 and secondary database 125 as described herein. Other components of database environment 100 (not illustrated in FIG. 1) can also utilize both primary database 120 and secondary database 125.

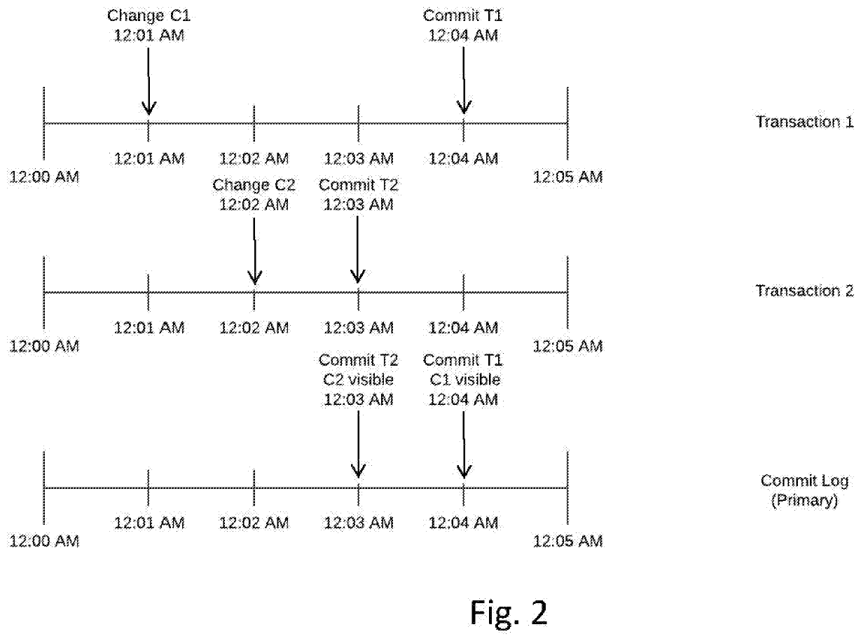

FIG. 2 is a timing illustration of two transactions within a database environment. The example of FIG. 2 illustrates two in-flight transactions (e.g., T1 and T2). In the example of FIG. 2, Transaction 1 modifies a database entity (E) at 12:01 AM (as indicated by Change C1). That change is committed at 12:04 AM (as indicated by Commit T1). Transaction 2 modifies the database entity (E) at 12:02 AM (as indicated by Change C2). That change is committed at 12:03 AM (as indicated by Commit T2). Thus, the transactions are committed to the database (e.g., primary database 120 of FIG. 1) and the transactions become visible at 12:03 AM (Change C2) and at 12:04 AM (Change C1).

If indexing rows are scanned (e.g., by indexer 140 of FIG. 1) on the database (e.g., primary database 120 of FIG. 1) at 12:02 AM, no rows are found for indexing. If indexing rows are scanned at 12:03:01 AM, the indexing row for C2 is found (e.g., using a MODSTAMP of 12:02 AM to null) and the entity table for E can be scanned immediately (e.g., using SYSTEM_MODSTAMP >=12:02 AM as a predicate) and Change C2 will be found.

If indexing rows are scanned at 12:04:01 AM, the indexing rows for C1 and C2 are found (e.g., using a MODSTAMP of 12:01 AM to null) and the entity table for E can be scanned immediately (e.g., using SYSTEM_MODSTAMP >=12:01 AM as a predicate) and Change C1 and Change C2 will be found. If indexing rows are scanned at 12:05:01 AM, the indexing rows for C1 and C2 are found (e.g., using a MODSTAMP of 12:01 AM to null) and the entity table for E can be scanned immediately (e.g., using SYSTEM_MODSTAMP >=12:01 AM as a predicate) and Change C1 and Change C2 will be found.

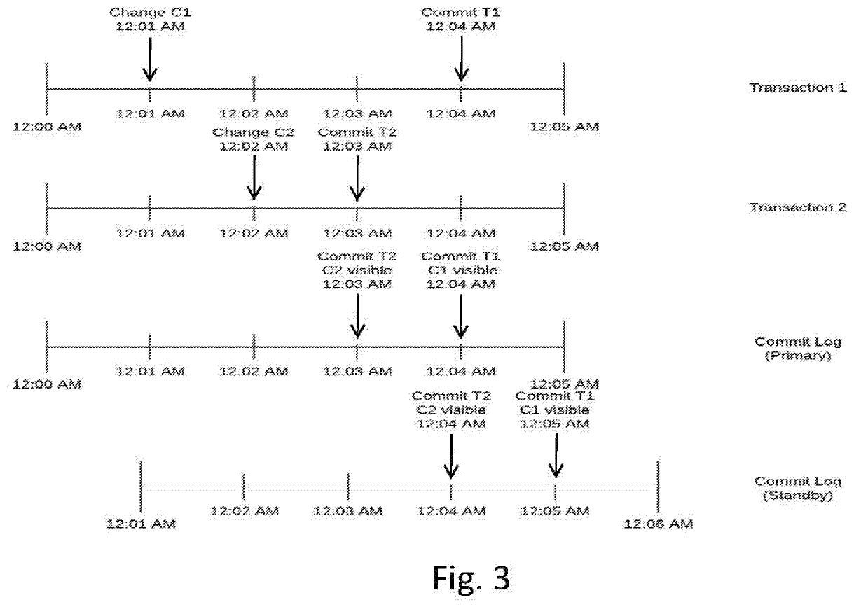

FIG. 3 is a timing illustration of two transactions within a database environment having a primary database and a standby (secondary) database. The example of FIG. 3 illustrates two in-flight transactions (e.g., T1 and T2) as assumes that the secondary (standby) database trails the primary database by one minute. In the example of FIG. 3, Transaction 1 modifies a database entity (E) at 12:01 AM (as indicated by Change C1). That change is committed to the primary database at 12:04 AM (as indicated by Commit T1) and to the secondary database at 12:05 AM (as indicated by Commit T1).

Transaction 2 modifies the database entity (E) at 12:02 AM (as indicated by Change C2). That change is committed to the primary database at 12:03 AM (as indicated by Commit T2) and to the secondary database at 12:04 AM (as indicated by Commit T2). Thus, the transactions are committed to the primary database and the transactions become visible at 12:03 AM (Change C2) and at 12:04 AM (Change C1) and the transactions are committed to the secondary database and the transactions become visible at 12:04 AM (Change C2) and at 12:05 AM (Change C1).

If indexing rows are scanned (e.g., by indexer 140 of FIG. 1) on the database at 12:02 AM, no rows are found for indexing. If indexing rows are scanned at 12:03:01 AM, the indexing row for C2 is found (e.g., using a MODSTAMP of 12:02 AM to null) and the entity table for E cannot be scanned immediately on the secondary database (e.g., using SYSTEM_MODSTAMP >=12:02 AM as a predicate) and Change C2 will not be found until the secondary database applies the commit of Change C2.

If indexing rows are scanned at 12:04:01 AM, the indexing rows for C1 and C2 are found (e.g., using a MODSTAMP of 12:01 AM to null) and the entity table for E cannot be scanned immediately on the secondary database (e.g., using SYSTEM_MODSTAMP >=12:01 AM as a predicate) and Change C1 and Change C2 will not be found until the secondary database applies the commit of Change C1 and Change C2. If indexing rows are scanned at 12:05:01 AM, the indexing rows for C1 and C2 are found (e.g., using a MODSTAMP of 12:01 AM to null) and the entity table for E can be scanned immediately (e.g., using SYSTEM_MODSTAMP >=12:01 AM as a predicate) and Change C1 and Change C2 will be found.

Thus, in order to safely read the entity table on the secondary database, enough time must have passed to be sure that the secondary database is caught up with the metadata used to determine the range of changes to be scanned. Various techniques to accomplish this are described in greater detail below.

As discussed above, the secondary database (e.g., ROCS) can be used for fetching data (e.g., from the entity table) when appropriate. In one embodiment, in order to guarantee that the secondary database is only used when it contains the required data. In one embodiment, the data to which the secondary database has replicated is compared to the date when the indexing batch was scheduled to be processed. In one embodiment, if the secondary database is up to date an INSTANT (or other indicator) greater than or equal to the INSTANT when the batch was created, the secondary database contains the data that the batch needs and can be used to fetch the entity to index for correct indexing. Otherwise, the primary database is utilized.

In one embodiment, the transaction that reads the entity table is read-only. Various techniques can be used to determine whether the secondary database is caught up with the metadata of the primary database to determine the range of changes to be scanned. In one embodiment, when moving a row from a last unindexed (e.g., CORE.LAST_UNINDEXED2) table to an unindexed work (e.g., CORE.LAST_UNINDEXED_WORK2) table, the time stamp can be pushed to the unindexed work table record. This time stamp can then be used by consumers of the data to determine if the secondary database has caught up to the point in time where the primary database created the work table record. In other words, the time stamp could be used to determine if the secondary database has the records that were on the primary database when the timespan describing when changes occurred for the entity was created.

Conceptually, this has some similarities with how replication chunks are defined. Replication operations can create “chunks” that describe a timespan that contains one or more changed rows. Those chunks have a creation date. The timespan described by different chunks can overlap. For example, there could be a chunk that covers 12:03 to 12:04 that was created at 12:07. There could be another chunk that covers 12:01 to 12:01 (e.g., one entity row) that was created at 12:08. Consumers can use chunk creation dates to determine whether all relevant changes have been collected.

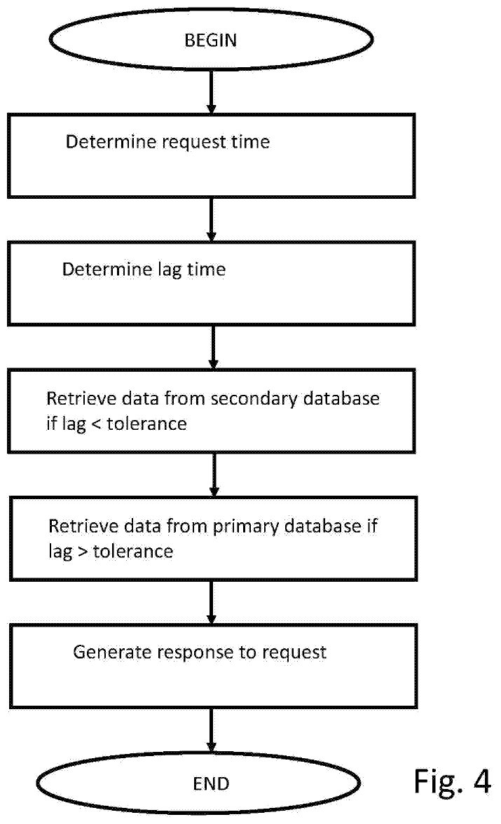

FIG. 4 is a flow diagram corresponding to one embodiment of a technique for tracking transactions. Specific examples are provided in terms of indexing in an environment having a primary database and a secondary database; however, the techniques described herein are more broadly applicable.

In one embodiment, a request time is determined, 410. In one embodiment, the request time is the MODSTAMP or other time indicator associated with a database request. The database request can be, for example, an indexing request.

In one embodiment, a lag time is determined (or retrieved from a database or other storage mechanism), 420. In one embodiment, an approximate lag time is determined by adding, for example, the time required to process the received changes (e.g., an apply lag), network lag time, other transmission lag time, etc. This can be referred to as the clock lag time.

In one embodiment, if the clock lag time is less that a pre-selected tolerance (e.g., 5 seconds, 45 seconds, 2 minutes, 5 minutes), then the requested data is read from the read-only database rather than the primary (e.g., read-write) database, 430. Under these conditions there is a low risk of data corruption. In one embodiment, if data corruption occurs during indexing, a second index pass will correct the corruption. In one embodiment, if the clock lag time is greater than the pre-selected tolerance, then the requested data is read from the primary database, 440.

A response to the request is generated, 450, using the data retrieved from the primary and/or the secondary databases. As discussed above, the primary database and the secondary database can be part of a multitenant environment. The following figures provide examples of multitenant environments in which the techniques described herein can be utilized.

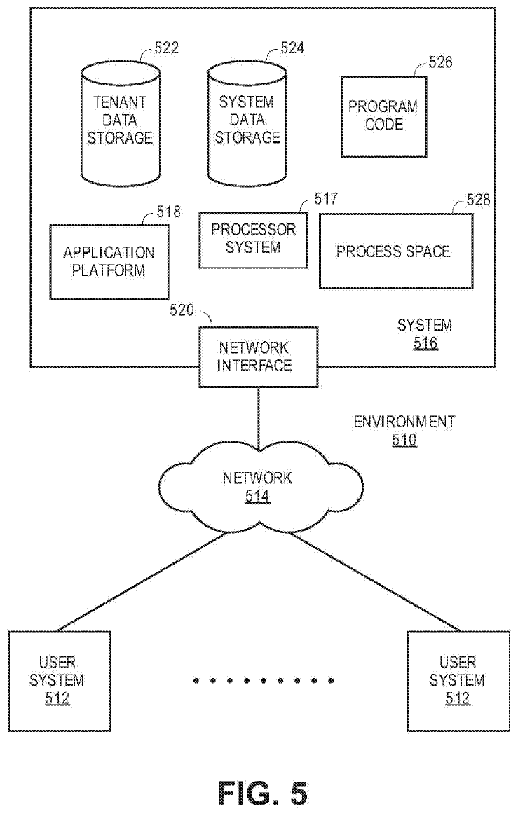

FIG. 5 illustrates a block diagram of an environment 510 wherein an on-demand database service might be used. Environment 510 may include user systems 512, network 514, system 516, processor system 517, application platform 518, network interface 520, tenant data storage 522, system data storage 524, program code 526, and process space 528. In other embodiments, environment 510 may not have all of the components listed and/or may have other elements instead of, or in addition to, those listed above.

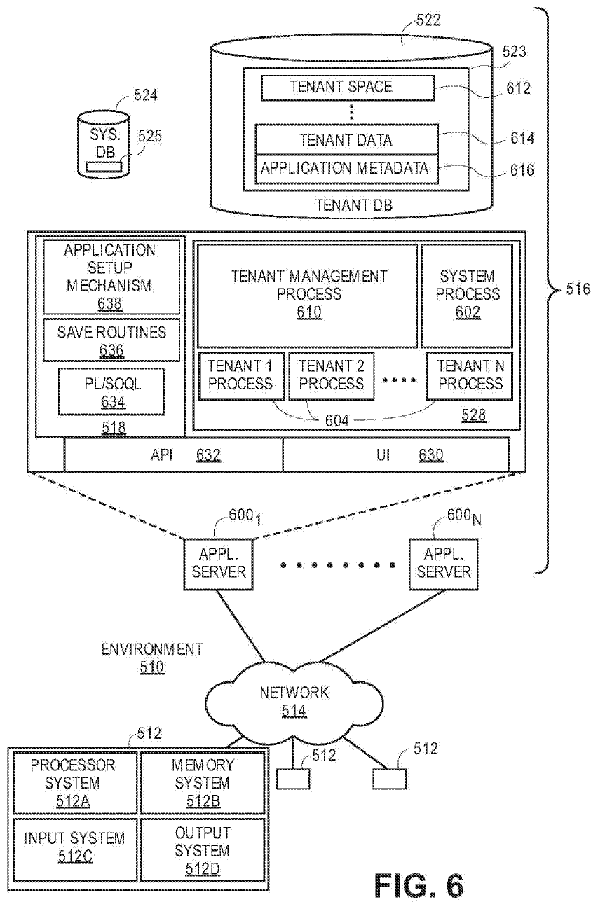

Environment 510 is an environment in which an on-demand database service exists. User system 512 may be any machine or system that is used by a user to access a database user system. For example, any of user systems 512 can be a handheld computing device, a mobile phone, a laptop computer, a work station, and/or a network of computing devices. As illustrated in herein FIG. 5 (and in more detail in FIG. 6) user systems 512 might interact via a network 514 with an on-demand database service, which is system 516.

An on-demand database service, such as system 516, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 516” and “system 516” will be used interchangeably herein. A database image may include one or more database objects. A relational database management system (RDMS) or the equivalent may execute storage and retrieval of information against the database object(s). Application platform 518 may be a framework that allows the applications of system 516 to run, such as the hardware and/or software, e.g., the operating system. In an embodiment, on-demand database service 516 may include an application platform 518 that enables creation, managing and executing one or more applications developed by the provider of the on-demand database service, users accessing the on-demand database service via user systems 512, or third party application developers accessing the on-demand database service via user systems 512.

The users of user systems 512 may differ in their respective capacities, and the capacity of a particular user system 512 might be entirely determined by permissions (permission levels) for the current user. For example, where a salesperson is using a particular user system 512 to interact with system 516, that user system has the capacities allotted to that salesperson. However, while an administrator is using that user system to interact with system 516, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 514 is any network or combination of networks of devices that communicate with one another. For example, network 514 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 512 might communicate with system 516 using TCP/IP and, at a higher network level, use other common Internet protocols to communicate, such as HTTP, FTP, AFS, WAP, etc. In an example where HTTP is used, user system 512 might include an HTTP client commonly referred to as a “browser” for sending and receiving HTTP messages to and from an HTTP server at system 516. Such an HTTP server might be implemented as the sole network interface between system 516 and network 514, but other techniques might be used as well or instead. In some implementations, the interface between system 516 and network 514 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 516, shown in FIG. 5, implements a web-based customer relationship management (CRM) system. For example, in one embodiment, system 516 includes application servers configured to implement and execute CRM software applications as well as provide related data, code, forms, webpages and other information to and from user systems 512 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 516 implements applications other than, or in addition to, a CRM application. For example, system 516 may provide tenant access to multiple hosted (standard and custom) applications, including a CRM application. User (or third party developer) applications, which may or may not include CRM, may be supported by the application platform 518, which manages creation, storage of the applications into one or more database objects and executing of the applications in a virtual machine in the process space of the system 516.

One arrangement for elements of system 516 is shown in FIG. 5, including a network interface 520, application platform 518, tenant data storage 522 for tenant data 523, system data storage 524 for system data 525 accessible to system 516 and possibly multiple tenants, program code 526 for implementing various functions of system 516, and a process space 528 for executing MTS system processes and tenant-specific processes, such as running applications as part of an application hosting service. Additional processes that may execute on system 516 include database indexing processes.

Several elements in the system shown in FIG. 5 include conventional, well-known elements that are explained only briefly here. For example, each user system 512 could include a desktop personal computer, workstation, laptop, PDA, cell phone, or any wireless access protocol (WAP) enabled device or any other computing device capable of interfacing directly or indirectly to the Internet or other network connection. User system 512 typically runs an HTTP client, e.g., a browsing program, such as Edge from Microsoft, Safari from Apple, Chrome from Google, or a WAP-enabled browser in the case of a cell phone, PDA or other wireless device, or the like, allowing a user (e.g., subscriber of the multi-tenant database system) of user system 512 to access, process and view information, pages and applications available to it from system 516 over network 514. Each user system 512 also typically includes one or more user interface devices, such as a keyboard, a mouse, touch pad, touch screen, pen or the like, for interacting with a graphical user interface (GUI) provided by the browser on a display (e.g., a monitor screen, LCD display, etc.) in conjunction with pages, forms, applications and other information provided by system 516 or other systems or servers. For example, the user interface device can be used to access data and applications hosted by system 516, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 512 and all of its components are operator configurable using applications, such as a browser, including computer code run using a central processing unit such as an Intel Core series processor or the like. Similarly, system 516 (and additional instances of an MTS, where more than one is present) and all of their components might be operator configurable using application(s) including computer code to run using a central processing unit such as processor system 517, which may include an Intel Core series processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 516 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 516 is configured to provide webpages, forms, applications, data and media content to user (client) systems 512 to support the access by user systems 512 as tenants of system 516. As such, system 516 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 6 also illustrates environment 510. However, in FIG. 6 elements of system 516 and various interconnections in an embodiment are further illustrated. FIG. 6 shows that user system 512 may include processor system 512A, memory system 512B, input system 512C, and output system 512D. FIG. 6 shows network 514 and system 516. FIG. 6 also shows that system 516 may include tenant data storage 522, tenant data 523, system data storage 524, system data 525, User Interface (UI) 630, Application Program Interface (API) 632, PL/SOQL 634, save routines 636, application setup mechanism 638, applications servers 600₁-600_{N}, system process space 602, tenant process spaces 604, tenant management process space 610, tenant storage area 612, user storage 614, and application metadata 616. In other embodiments, environment 510 may not have the same elements as those listed above and/or may have other elements instead of, or in addition to, those listed above.

User system 512, network 514, system 516, tenant data storage 522, and system data storage 524 were discussed above in FIG. 5. Regarding user system 512, processor system 512A may be any combination of one or more processors. Memory system 512B may be any combination of one or more memory devices, short term, and/or long term memory. Input system 512C may be any combination of input devices, such as one or more keyboards, mice, trackballs, scanners, cameras, and/or interfaces to networks. Output system 512D may be any combination of output devices, such as one or more monitors, printers, and/or interfaces to networks. As shown by FIG. 6, system 516 may include a network interface 520 (of FIG. 5) implemented as a set of HTTP application servers 600, an application platform 518, tenant data storage 522, and system data storage 524. Also shown is system process space 602, including individual tenant process spaces 604 and a tenant management process space 610. Each application server 600 may be configured to tenant data storage 522 and the tenant data 523 therein, and system data storage 524 and the system data 525 therein to serve requests of user systems 512. The tenant data 523 might be divided into individual tenant storage areas 612, which can be either a physical arrangement and/or a logical arrangement of data. Within each tenant storage area 612, user storage 614 and application metadata 616 might be similarly allocated for each user. For example, a copy of a user's most recently used (MRU) items might be stored to user storage 614. Similarly, a copy of MRU items for an entire organization that is a tenant might be stored to tenant storage area 612. A UI 630 provides a user interface and an API 632 provides an application programmer interface to system 516 resident processes to users and/or developers at user systems 512. The tenant data and the system data may be stored in various databases, such as one or more Oracle™ databases.

Application platform 518 includes an application setup mechanism 638 that supports application developers' creation and management of applications, which may be saved as metadata into tenant data storage 522 by save routines 636 for execution by subscribers as one or more tenant process spaces 604 managed by tenant management process 610 for example. Invocations to such applications may be coded using PL/SOQL 634 that provides a programming language style interface extension to API 632. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 616 for the subscriber making the invocation and executing the metadata as an application in a virtual machine.

Each application server 600 may be communicably coupled to database systems, e.g., having access to system data 525 and tenant data 523, via a different network connection. For example, one application server 600₁ might be coupled via the network 514 (e.g., the Internet), another application server 600_{N-1} might be coupled via a direct network link, and another application server 600_{N} might be coupled by yet a different network connection. Transfer Control Protocol and Internet Protocol (TCP/IP) are typical protocols for communicating between application servers 600 and the database system. However, it will be apparent to one skilled in the art that other transport protocols may be used to optimize the system depending on the network interconnect used.

In certain embodiments, each application server 600 is configured to handle requests for any user associated with any organization that is a tenant. Because it is desirable to be able to add and remove application servers from the server pool at any time for any reason, there is preferably no server affinity for a user and/or organization to a specific application server 600. In one embodiment, therefore, an interface system implementing a load balancing function (e.g., an F5 BIG-IP load balancer) is communicably coupled between the application servers 600 and the user systems 512 to distribute requests to the application servers 600. In one embodiment, the load balancer uses a least connections algorithm to route user requests to the application servers 600. Other examples of load balancing algorithms, such as round robin and observed response time, also can be used. For example, in certain embodiments, three consecutive requests from the same user could hit three different application servers 600, and three requests from different users could hit the same application server 600. In this manner, system 516 is multi-tenant, wherein system 516 handles storage of, and access to, different objects, data and applications across disparate users and organizations.

As an example of storage, one tenant might be a company that employs a sales force where each salesperson uses system 516 to manage their sales process. Thus, a user might maintain contact data, leads data, customer follow-up data, performance data, goals and progress data, etc., all applicable to that user's personal sales process (e.g., in tenant data storage 522). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 516 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 516 might also maintain system level data usable by multiple tenants or other data. Such system level data might include industry reports, news, postings, and the like that are sharable among tenants.

In certain embodiments, user systems 512 (which may be client systems) communicate with application servers 600 to request and update system-level and tenant-level data from system 516 that may require sending one or more queries to tenant data storage 522 and/or system data storage 524. System 516 (e.g., an application server 600 in system 516) automatically generates one or more SQL statements (e.g., one or more SQL queries) that are designed to access the desired information. System data storage 524 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A non-transitory computer-readable medium having stored thereon instructions that, when executed by one or more processors, are configurable to cause the one or more processors to:
determine a time associated with a database request;
determine a lag time associated with data in a secondary database;
retrieve data to service the database request from the secondary database if the lag time is less than a pre-selected tolerance time for corresponding data;
retrieve data to service the database request from the primary database if the lag time is greater than a pre-selected tolerance time for corresponding data;
generate a response to the database request with the retrieved data.

2. The non-transitory computer-readable medium of claim 1 wherein the database request comprises an indexing request.

3. The non-transitory computer-readable medium of claim 1 wherein the secondary database comprises a read-only database.

4. The non-transitory computer-readable medium of claim 1 wherein the lag time is a sum of database processing time to process data changes and transport lag.

5. The non-transitory computer-readable medium of claim 1 wherein the primary database and the secondary database are both part of a multitenant database environment.

6. A method comprising:
determining a time associated with a database request;
determining a lag time associated with data in a secondary database;
retrieving data to service the database request from the secondary database if the lag time is less than a pre-selected tolerance time for corresponding data;
retrieving data to service the database request from the primary database if the lag time is greater than a pre-selected tolerance time for corresponding data;
generating a response to the database request with the retrieved data.

7. The method of claim 6 wherein the database request comprises an indexing request.

8. The method of claim 6 wherein the secondary database comprises a read-only database.

9. The method of claim 6 wherein the lag time is a sum of database processing time to process data changes and transport lag.

10. The method of claim 6 wherein the primary database and the secondary database are both part of a multitenant database environment.

11. A system comprising:
a physical memory system;
one or more hardware processors coupled with the physical memory system, the one or more hardware processors configurable to determine a time associated with a database request, to determine a lag time associated with data in a secondary database, to retrieve data to service the database request from the secondary database if the lag time is less than a pre-selected tolerance time for corresponding data, to retrieve data to service the database request from the primary database if the lag time is greater than a pre-selected tolerance time for corresponding data, and to generate a response to the database request with the retrieved data.

12. The system of claim 11 wherein the database request comprises an indexing request.

13. The system of claim 11 wherein the secondary database comprises a read-only database.

14. The system of claim 11 wherein the lag time is a sum of database processing time to process data changes and transport lag.

15. The system of claim 11 wherein the primary database and the secondary database are both part of a multitenant database environment.
